(19) United States
(12) Patent Application Publication
(10) Pub. No.: US 2025/0245974 A1
(43) Pub. Date: Jul. 31, 2025

(54) Method for Generating Synthetic Sensor Data of Specific Sensor Generation

(71) Applicant: Robert Bosch GmbH, Stuttgart (DE)

(72) Inventors: Rohan Gugale, Ludwigsburg (DE); Erick Gonzalez Rodriguez, Hemmingen (DE); Marian Keck, Mundelsheim (DE)

(21) Appl. No.: 19/035,013

(22) Filed: Jan. 23, 2025

(30) Foreign Application Priority Data
Jan. 26, 2024 (DE) 10 2024 200 725.0

(51) Int. Cl. G06V 10/776; G06V 10/20; G06V 10/764; G06V 10/98; G06V 20/54

(52) U.S. Cl. CPC G06V 10/776; G06V 10/20; G06V 10/764; G06V 10/98; G06V 20/54

(57) ABSTRACT

A method for generating synthetic sensor data of a specific sensor generation includes (i) providing sensor data, wherein the sensor data results from a detection of at least one sensor of a first sensor type, (ii) compressing the sensor data using an encoder module in order to generate a compressed image of the sensor data, and (iii) generating the synthetic sensor data based on at least one characteristic of a second sensor type, at least one characteristic of the specific sensor generation, and the compressed image of the sensor data using a common decoder module and a specific decoder module for the specific sensor generation. A computer program, an apparatus, and a storage medium for this purpose is also disclosed.

This application claims priority under 35 U.S.C. § 119 to application no. DE 10 2024 200 725.0, filed on Jan. 26, 2024 in Germany, the disclosure of which is incorporated herein by reference in its entirety.

The disclosure relates to a method for generating synthetic sensor data of a specific sensor generation. The disclosure further relates to a computer program, an apparatus, and a storage medium for this purpose.

### BACKGROUND

Generating synthetic sensor data by machine-learning models is an advanced approach in artificial intelligence that allows for realistic but artificially generated data to be generated that simulates real-world sensor outputs. This technique is in particular useful in scenarios where access to true sensor data is limited or impossible, whether due to cost, privacy concerns, or practical limitations. Machine-learning models, in particular those based on neural networks, can be trained so as to capture characteristics and patterns of real sensor data and subsequently generate data similar to those. This allows for more robust and efficient machine-learning systems to be developed, because these models can be trained with a variety of data that reflect reality in different scenarios and conditions.

However, it can be necessary for specific sensor generations to train a corresponding machine-learning model each time according to the methods known in the prior art.

### SUMMARY

The subject-matter of the disclosure is a method, a computer program, an apparatus, and a computer-readable storage medium having the features set forth below. Further features and details of the disclosure will emerge from the description, and the drawings. Features and details which are described in connection with the method according to the disclosure naturally also apply in connection with the computer program according to the disclosure, the apparatus according to the disclosure, and the computer-readable storage medium according to the disclosure, and vice versa in each case, so that reference is always or can always be made to the individual aspects of the disclosure with respect to the disclosure.

The subject-matter of the disclosure is in particular a method for generating synthetic sensor data of a specific sensor generation, comprising the following steps, wherein the steps can be repeated and/or carried out sequentially. The specific sensor generation is in particular a specific model, for example a new product line, of a sensor, wherein the specific model also relates to particular physical characteristics or feature characteristics.

In a first step, preferably sensor data is provided, wherein the sensor data results from a detection of at least one sensor of a first sensor type. For example, the sensor data can be image data. For example, the at least one sensor can be a camera sensor or also an infrared camera sensor, a radar sensor, a LiDAR sensor, or an ultrasonic sensor, such that the image data can also be configured as infrared, radar, LiDAR, or ultrasonic image data. However, the preceding list is not exhaustive, so that other sensors are also conceivable in addition to those mentioned.

In a further step, the sensor data is preferably compressed using an encoder module in order to generate a compressed image of the sensor data. In other words, the sensor data is in particular transferred into a latent space. In so doing, a feature vector can be extracted based on the sensor data, which represents essential features of the sensor data. Thus, in other words, the encoder module is in particular a component that is configured so as to convert the sensor data into a more compact form. This conversion preferably aims to extract essential features and/or structures from the sensor data while reducing redundant or non-essential information.

In a further step, the synthetic sensor data is preferably generated based on at least one characteristic of a second sensor type, at least one characteristic of the specific sensor generation, and the compressed image of the sensor data using a common decoder module and a decoder module specific for the specific sensor generation of the second sensor type. The specific sensor generation is in particular a specific sensor generation of the second sensor type. For example, if the second type of sensor is specific to a radar sensor technology, the at least one characteristic can describe fundamental characteristics for sensor data from radar sensors. The specific generation of sensors can then be, for example, a particular model or product line of a radar sensor. For example, the at least one characteristic of the specific sensor generation can be a number of transmitter antennas of the radar sensor or an orientation of transmitter and receiver antennas of the radar sensor. In addition, one characteristic of the specific generation of sensors can be how much data is present for this specific generation of sensors. According to the amount of data present, the machine-learning model adjustment discussed in a paragraph below can also be influenced, i.e. the less data there is, the less the specific generation of the sensor is preferably considered in the machine-learning model adjustment with respect to the common decoder module. An advantage can be that, during a back propagation, for the training of the entire machine-learning model (i.e. in particular a machine-learning model comprising the encoder and the decoder part), weights and parameters for the sensor generation-specific decoder module can be adjusted based on the training data for the specific sensor generation. However, the effect of back-propagation on weights and parameters of the common decoder module can be compared relative to the amount of training data available for that specific sensor generation, compared to, or as a ratio of, the data available together for all sensor generations and training data. For example, for a new generation of sensors that are still in pre-development, the sensor generation-specific decoder module can be adjusted with the limited available data, but the common decoder module is preferably adjusted only in proportion to the amount of the training data for the new generation of sensors compared to the older generations of sensors. One option would also be to estimate the sensor generation-specific or subgeneration-specific decoder module based on the sensor generation or sensor subgeneration characteristics for pre-estimation of the synthetic sensor data for this new specific decoder module. This estimate can be derived based on knowledge of the other sensor generation-specific decoder modules and their corresponding sensor generation-specific characteristics. This approach could also be used in order to initialize the weights and parameters for the new sensor generation-specific or subgeneration-specific decoder module being designed and thus reduce the training times. At least one further plane can also be provided for a subgeneration of the sensor generation. Accordingly, the synthetic sensor data would be generated further based on at least one characteristic of the at least one subgeneration and further using a decoder module specific to the subgeneration of the second sensor type. It can be contemplated that at least two decoder modules specific to the specific sensor generation of the second sensor type are provided. A matching common decoder module can then be determined or selected based on the at least one characteristic of the second sensor type. Further, a dedicated decoder module specific to the specific sensor generation of the second sensor type can be determined or selected by a selector module based on the at least one characteristic of the specific sensor generation of the second sensor type, or by a provided input, for example a user, comprising a description of the specific sensor generation.

The first sensor type and the second sensor type can be specific to a different sensor technology or to the same sensor technology. Possible sensor technologies include, for example, a camera sensor, an infrared camera sensor, a radar sensor, a LiDAR sensor, or an ultrasonic sensor. However, the preceding list is not exhaustive, so that in addition to the aforementioned, other analog sensor technologies are also applicable. For example, the first sensor type could be a radar imaging apparatus and the second sensor type could be a radar sensor, for example in a vehicle.

According to an advantageous further development of the disclosure, it can be provided that the common decoder module is a trained machine-learning model which is trained so as to pre-process the compressed image for the second sensor type, and in particular for a further sensor type. The pre-processing preferably comprises at least a partial reconstruction of the synthetic sensor data to be generated. The decoder module specific to the specific sensor generation of the second sensor type is preferably a further trained machine-learning model which is trained so as to generate the synthetic sensor data based on the pre-processed compressed image.

Furthermore, in the context of the disclosure, it is contemplated that the encoder module, the common decoder module, and the decoder module specific to the specific sensor generation of the second sensor type are each a machine-learning model, in particular a neural network, wherein the encoder module is preferably a foundation machine-learning model. A foundation machine-learning model is in particular a comprehensive, pre-trained machine-learning model based on a large amount of heterogeneous data. For example, it serves as a basic architecture on which more specific and customized models can be developed for a variety of applications. In particular, foundation machine-learning models are characterized by the ability to recognize and generalize complex patterns and interrelationships in large data sets. The aforementioned machine-learning models are preferably each trained machine-learning models. It can be provided for the training of various common decoder modules and/or different decoder modules specific to the specific sensor generation of the second sensor type. Weights of this encoder module can be adjusted during the training. Furthermore, in a training of different decoder modules specific to the specific sensor generation of the second sensor type, the same common decoder module can be provided. Weights of this common decoder module and also of the encoder module can be adjusted during the training, respectively.

Alternatively, it is also contemplated that the encoder module, the common decoder module, and the decoder module specific to the specific sensor generation of the second sensor type are configured and trained as a single machine-learning model, in particular a foundation machine-learning model.

It can be contemplated in the context of the disclosure that an encoder module specific to a sensor generation of the first sensor type is further provided, and the compression is carried out using the encoder module specific to the sensor generation of the first sensor type and the encoder module. As a result, the compression of the sensor data can be carried out specifically for a generation of the first sensor type, and thus more precisely. In other words, according to this alternative, the encoder side is also designed in multiple stages. For example, a specific generation of sensors can be accounted for by the corresponding encoder module specific to the sensor generation of the first sensor type.

A further advantage in the context of the disclosure can be achieved if the method further comprises the following step:
emulating a sensor of the second sensor type based on the generated synthetic sensor data.

For example, an application is conceivable in which radar data for a radar apparatus is emulated and thus provided based on sensor data in the form of image data of a camera.

In addition, the disclosure can advantageously provide that the method further comprises the following steps:
providing further sensor data, wherein the further sensor data is specific to the second sensor type and represents an identical scene as the sensor data, wherein the further sensor data results from a detection of at least one further sensor,
comparing the detected further sensor data to the generated synthetic sensor data,
detecting a fault or an interference of the at least one further sensor based on a result of the comparison.

The scene can be specific to a movement in an environment, or it can represent the latter. For example, as part of the above steps, the sensor data could be simultaneously detected with a sensor of the first sensor type, and the further sensor data could be simultaneously detected with a sensor of the second sensor type in order to capture the same scene. The synthetic sensor data can advantageously be generated so precisely that a check of a real sensor, i.e. detection of errors or impairments of the sensor, is enabled. An impairment could be, for example, a weather-related visual limitation of a camera sensor. Then, based on the sensor data of the sensor of the first sensor type, the synthetic sensor data could be generated. A fault or impairment of the at least one sensor of the first sensor type could alternatively also be detected based on the comparison.

It can optionally be possible that the method further comprises the following step:
balancing the fault or the impairment of the at least one further sensor based on the synthetic sensor data by modifying the further detected sensor data based on the synthetic sensor data.

For example, an impairment, such as a weather-related visual limitation of a camera sensor, could advantageously be supplemented by the generated synthetic sensor data, because, optionally, a sensor of the first sensor type, such as a radar sensor, that captures the sensor data, may not be restricted. If, based on the comparison, a fault or impairment of the at least one sensor of the first sensor type has been detected, it can be provided in one alternative that this fault or impairment is also compensated for by a corresponding modification. However, an opposite method may be necessary in order to generate corresponding synthetic sensor data. “Opposite” refers in particular to the fact that a corresponding encoder part according to the disclosure would then be necessary for the second sensor type and a corresponding decoder part according to the disclosure for the first sensor type.

According to a further possibility, it can be provided that the method further comprises the following step:
generating or verifying at least one label for a training of a machine-learning model in a training data set, wherein the training data set is specific to sensor data of the second sensor type.

The training data record can be a training data record for a machine-learning model that includes the labels used for training. Advantageously, the synthetic sensor data generated can provide increased variability in the training data set. For example, generating the at least one label can occur when an object not yet found in the training data set or a known object with additional details is simulated by the synthetic sensor data.

It is further contemplated that the sensor data and the synthetic sensor data are specific to a road traffic, and the method further comprises the following step:
generating or adjusting a road signature based on the generated synthetic sensor data.

A road signature, in particular, denotes a characteristic pattern or series of features that characterize a particular road or road network. The road signature can include various elements, such as those of a physical and abstract nature. Physical features include, for example, a width and quality of a road, a type of roadside development, road markings, curbs, walkways, and road lighting. Special features such as trees, green strips, or special architectural elements can also be physical features. Furthermore, a road signature can include a traffic pattern, for example, a type and intensity of a traffic flow, primary manner of transportation (e.g. cars, wheels, pedestrians), and a presence of public transportation. For example, the present disclosure can advantageously provide for an updating of the road signature from one generation of sensors to a next generation of sensors, which can provide further details or features in the road signature.

It is possible that the method according to the disclosure is used in a vehicle. The vehicle can, for example, be designed as a motor vehicle and/or a passenger vehicle and/or an autonomous vehicle. The vehicle can comprise a vehicle apparatus, e.g., for providing an autonomous driving function and/or a driver assistance system. The vehicle apparatus can be configured so as to control and/or accelerate and/or brake and/or steer the vehicle, at least partially automatically.

A further subject-matter of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

A further subject-matter of the disclosure is an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution.

A further subject-matter of the disclosure can be a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a sensor generation, a sensor, an apparatus, a storage medium, and a computer program according to exemplary embodiments of the disclosure,

FIG. 2 a schematic illustration of a method according to exemplary embodiments of the disclosure.

### DETAILED DESCRIPTION

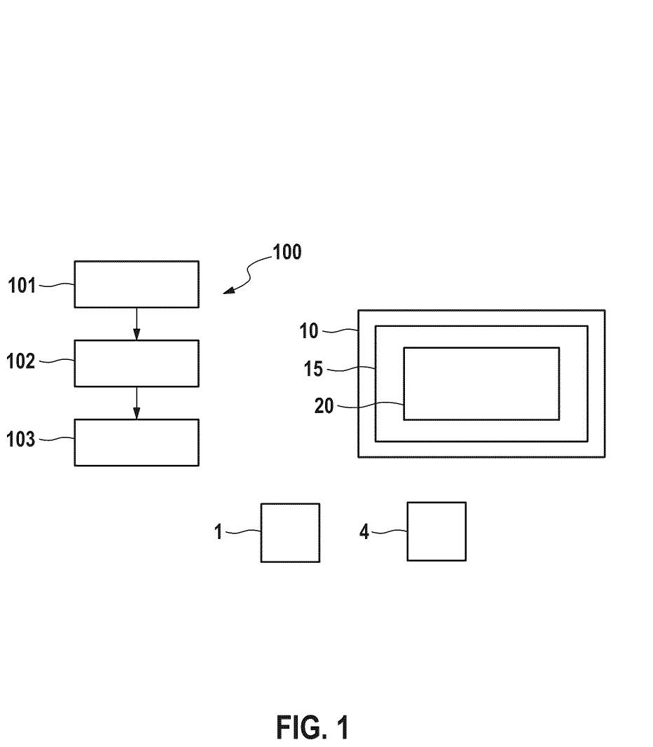

FIG. 1 schematically illustrates a method 100, a sensor generation 1, a sensor 4, an apparatus 10, a storage medium 15, and a computer program 20 according to exemplary embodiments of the disclosure.

In particular, FIG. 1 shows an exemplary embodiment of a method 100 for generating synthetic sensor data 2 of a specific sensor generation 1. In a first step 101, sensor data 3 is provided, wherein the sensor data 3 results from a detection of at least one sensor 4 of a first sensor type. In a second step 102, the sensor data 3 is compressed using an encoder module 5 in order to generate a compressed image 6 of the sensor data 3. In a third step 103, the synthetic sensor data 2 generated based on at least one characteristic of a second sensor type 7, at least one characteristic of the specific sensor generation 8, and the compressed image 6 of the sensor data 3 using a common decoder module 9 and a specific decoder module 11 for the specific sensor generation 1. The first sensor type and the second sensor type are specific to a different sensor technology, but can also be specific for the same sensor technology. For example, the first sensor type could be a radar imaging apparatus and the second sensor type could be a radar sensor, for example in a vehicle.

In particular, the present disclosure according to one exemplary embodiment utilizes a machine-learning model, preferably a generative machine-learning model, for a generation of synthetic sensor data 2, such as reflections for a sensor generation 1 based on a scenario composed of sensor data 3, such as image or video stream. In particular, a foundation machine-learning model is used for the machine-learning model. It should preferably be possible to use the latter over a plurality of sensor generations 1.

For this purpose, an input of sensor data 3 of a sensor technology, for example a camera or LiDAR sensor 4, is preferably provided, and an output of synthetic sensor data 2 is generated based on this input, which is specific to a further sensor technology, such as reflections for radar, LiDAR, or ultrasonic sensors.

A possible architecture of a machine-learning model, which can generate synthetic sensor data 2 for different sensor generations 1, will be described below. In particular, the machine-learning model can be improved for all sensor generations 1, even when only training data of one of the sensor generations 1 is used for the training. For example, the machine-learning model can be configured as a “plug-and-play” solution in which the architecture depends on the input and the required output for the specific sensor generation 1. With the aid of an encoder module 5 or a similar block, a compressed, i.e. in particular low-dimensional, image 6 can be generated based on the input. Depending on the specific sensor generation 1 present, the subsequent decoder modules can be a “plug-and-play” when the input remains the same. According to exemplary embodiments, a common decoder module 9 and at least one sensor generation-specific 1 or sensor sub-generation-specific decoder module 11 can be provided for a specific sensor type.

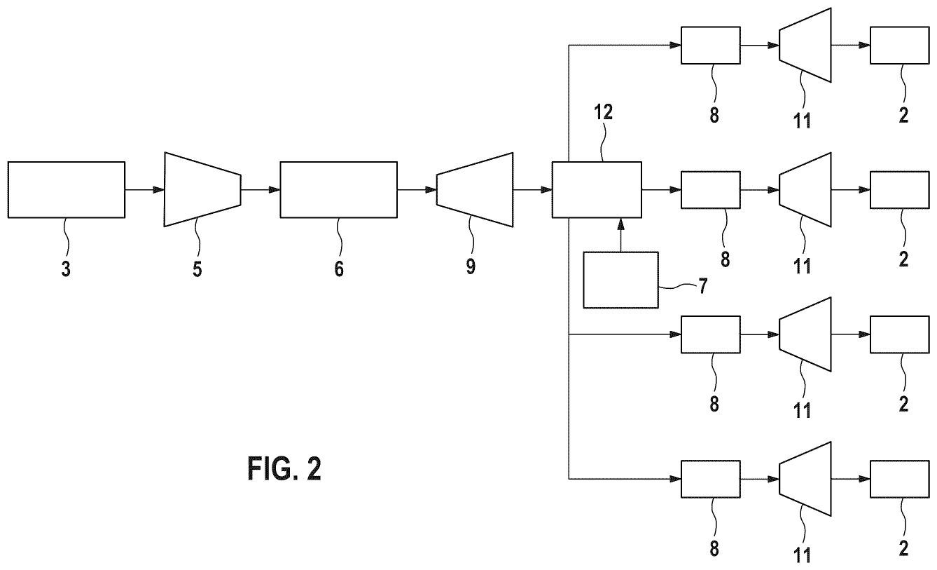

One exemplary embodiment of a method according to such a “plug-and-play” solution is shown in FIG. 2. Sensor data 3 is first provided to an encoder module 5. The encoder module 5 compresses the sensor data 3 into a compressed image 6 of the sensor data 3. Subsequently, a common decoder module 9 pre-processes this compressed image 6. A next step in this embodiment is a selector 12, which receives as an input at least one characteristic of a second sensor type 7 for which the synthetic sensor data 2 is to be generated. Subsequently, for a specific sensor generation 1 in the present case, the characteristic of the second sensor type 7 and at least one characteristic 8 can be provided in order to generate the respective synthetic sensor data 2 in a subsequent step by a decoder module 11 specific for the specific sensor generation of the second sensor type.

Due to the modular architecture, according to exemplary embodiments, the encoder module 5 can also be reused for a different type of sensor having the same input, i.e. sensor data 3 specific to an identical type of sensor 4, for example a camera sensor. For example, an encoder module 5 from a machine-learning model for inputting image data and outputting radar reflections could also be reused for machine-learning models for inputting image data and outputting ultrasonic or LiDAR sensor data 3.

One advantage of the method according to exemplary embodiments is that, in particular, even with training data for a specific sensor generation 1, further parts such as the encoder module 5 or the entire machine-learning model, i.e. which is in particular configured as a foundation machine-learning model, can be trained and improved. Effects of the training on the sensor generation-specific decoder module 11 can thus be greater. In the case of back-propagation for fine-tuning of weights, for example, the sensor generation-specific decoder module 11 is largely fine-tuned, while the influence on the common decoder module 9 is lower. The proportion of effects is based in particular on the sensor generation-specific characteristics.

The at least one characteristic of the specific sensor generation 8 can also comprise multiple sensor generations 1 that define aspects such as a number of transmitter antennas, an orientation of transmitter and receiver antennas, or also an amount of training data available for this specific sensor generation 1 relative to a total amount of the training data for the entire training model for all generations. Thus, the overall machine-learning model can also be improved by training for a particular generation of sensors 1.

With the disclosure, according to exemplary embodiments, an estimation of performance for a future sensor generation 1 is advantageously possible. Using the method described above, it is in particular possible to create an estimate, for example of reflections, for a future sensor generation 1, such as a sensor hardware front end for a particular scenario. In this case, for example, only a few important characteristics of the new sensor generation 1 can be known, such as a number of transmitter antennas of the new sensor generation 1 and/or an orientation of the antennas. If necessary, the sensor generation-specific decoder module 11 for this new sensor generation 1 could also be estimated with knowledge from the previous sensor generation-specific decoder modules 11 and their corresponding sensor generation-specific characteristics 8 along with the new sensor generation-specific characteristics 8. With this approach, for example, the reflections for a particular scenario for the new sensor generation 1 can be generated in order to pre-validate the performance of the sensor 4 for those particular scenarios. This can advantageously accelerate development of the front-end hardware for new sensor generations 1 through early feedback.

Furthermore, a generation of the synthetic sensor data 2, such as reflections using the sensor data 3, such as an image or video stream at the input of the highest resolution, such as for a radar imager, can be provided, which can then be simulated by a target simulator. The scene can then be used in order to simulate current sensor generations 1, depending on their processing capabilities, which the specific sensor generation 1 for example perceived or could not perceive.

Using an emulator, synthetic sensor data 2 can be generated for any desired scenario. Subsequently, any desired sensor generation 1 to be tested can be used with its own specific characteristics and, depending on the HW configuration of the sensor generation 1 being tested, the same synthetic sensor data 2 can be used for all generations of the sensor hardware in the loop simulations.

For example, the emulator cells emulate the reflections of an object, and, based on the cells triggered by the electromagnetic waves received from the actual sensor 4 to be tested, the corresponding emulation can be sent back from the emulator cells to the actual HW to be tested. With such an approach, specific key scenarios can be simulated using the target simulator in order to determine the sensor generation 1 that provides the best performance for such scenarios. It would also be possible to accelerate the development of HW front ends for sensors through early validation of their performance.

Furthermore, with the disclosure according to exemplary embodiments, an early merger can be carried out for performance improvement and first-person vehicle location in sensor merger units. In particular, a zonal architecture is increasingly provided in vehicles in which vehicle computers are used which process the data from multiple sensors in order to merge the data for perception of the environment. The method according to exemplary embodiments for generating the synthetic sensor data 2, for example reflections, can be embedded in the central computer that generates the synthetic sensor data 2 from the sensor data 3, i.e. a camera or video stream, for example, and can be identical to the further sensor data provided by the individual sensor generations, e.g. the radar sensors. This can provide early merger feedback for the sensor data of multiple sensors such as camera and radar and can also improve the overall performance of the merger system. In addition, in the event of discrepancies between different sensors, such as camera/radar/etc., it could be helpful for notification.

During the early development phases of the merger units and the A/B sensor sample phases, a direct feedback can be provided regarding the performance of a sensor system, or a specific sensor generation 1, respectively. For example, a merger unit can obtain sensor data 3 of the radar sensors to be tested. The merger unit can also carry out the method 100 proposed above for generating synthetic sensor data 3, in particular reflections based on the sensor data 3, in particular camera images. Based on the generated synthetic sensor data 3, in particular reflections, positions of objects can be determined. These determined positions can be compared to the positions actually provided by the radar sensors. If there is a discrepancy between the two, a snapshot can be taken of the camera image and the positions of the objects provided by the radar sensors, if possible, with a small description. The snapshot data can be analyzed later for performance improvement.

The machine-learning model proposed above can be employed, in particular in the central merger unit, and can continue to generate the synthetic sensor data 2 such as reflections for the specific sensor generation 1 for which it was trained based on faulty or impaired sensor data 3, such as a camera input. A sensor 4, which is actually mounted on the vehicle, also preferably processes the sensor data 3, in particular reflections, which it captures. The faulty or impaired sensor data 3 can be analyzed based on the synthetic sensor data 2 and used as input to the camera system that was unable to properly detect the reflections due to the light conditions, the dirty lens, etc.

Furthermore, a correction of a sensor 4 can be provided, for example, a camera perception in the event of problems, for example, due to light conditions or a dirty lens. The method according to exemplary embodiments could also be trained so as to generate synthetic sensor data 2, such as a camera image, based on sensor data 3, such as reflections of a sensor 4, such as radar, LiDAR, etc., at the input. The generated synthetic sensor data 2, in particular a generated camera image, can then be compared to the actual sensor data 3, such as a camera image, in order to correct the actual sensor data 3 or the actual camera image, respectively.

Various sensor system models known in the prior art that are used in order to estimate sensor performance for a particular scenario are sometimes unrealistic and, in particular, have lower performance, such as the RAYTRACING model used for radar systems. With the above proposed method according to exemplary embodiments, which can be trained for a desired performance level, the sensor system models required for “X—in the loop simulations” would no longer be needed. The at least one described machine-learning model according to exemplary embodiments can be trained with sufficient training data so as to come very close to reality, until the sensor system models are mature enough. The sensor system models could also be improved with the machine-learning models suggested above in order to increase accuracy.

For example, the method according to exemplary embodiments can also be used in order to generate reflections from an image. The reflections are then, in particular, processed without an actual sensor HW on computers using the sensor algorithms in order to obtain objects and their position relative to the scenario at the output. This object information can then be used in order to label the data for the camera image, i.e. with labels, or to validate the labels for the camera image. In this way, the quality of the labels of camera images can be improved. The proposed idea can be used in order to provide labels of any desired sensor such as camera/radar/LiDAR/etc.

As sensor generation 1 progresses, road signatures of a previous sensor generation 1 could become invalid in the future, because more objects can be perceived with the newer sensor generations 1 or with improved performance or accuracy. For example, radar systems can currently generate locations with fewer reflections from the objects, while the future sensor generation 1 of radar imagers could be able to generate point clouds of objects and thus detect more objects. With the method according to exemplary embodiments, it can be possible to also use road signatures from previous sensor generations 1 for the newer ones. For this purpose, for example, reflections from a camera image for a newer sensor generation 1 can be generated when characteristics of the newer sensor generation 1 are known. The reflections generated by the newer sensor generation 1 can then be processed with the newer generation characteristics in order to output the detected objects. Static objects such as guardrails along the road or road signs from the output can be mapped onto the existing sensor road signature objects, and the delta between the two can be added to the road signature for the newer generation. Thus, for example, when a vehicle equipped with the newer sensor generation 1 is traveling along the road, it will have access to the generation-specific road signature from a cloud. The method according to exemplary embodiments thus offers in particular the possibility of an incremental road sensor signature for the updating of sensor generations 1.

The above explanation of the embodiments describes the present disclosure solely within the scope of examples. Of course, individual features of the embodiments can be freely combined with one a further, insofar as technically feasible, without leaving the scope of the present disclosure.

What is claimed is:

1. A method for generating synthetic sensor data of a specific sensor generation, comprising:
providing sensor data, wherein the sensor data results from a detection of at least one sensor of a first sensor type;
compressing the sensor data using an encoder module in order to generate a compressed image of the sensor data; and
generating the synthetic sensor data based on at least one characteristic of a second sensor type, at least one characteristic of the specific sensor generation, and the compressed image of the sensor data using a common decoder module and a specific decoder module for the specific sensor generation.

2. The method according to claim 1, wherein:
the common decoder module is a trained machine-learning model which is trained so as to pre-process the compressed image for the second sensor type, and
the decoder module specific to the specific sensor generation of the second sensor type is a further trained machine-learning model which is trained so as to generate the synthetic sensor data based on the pre-processed compressed image.

3. The method according to claim 1, wherein:
the encoder module, the common decoder module, and the decoder module specific to the specific sensor generation of the second sensor type are each a machine-learning model, and
the encoder module is a foundation machine-learning model.

4. The method according to claim 1, further comprising an encoder module specific to a sensor generation of the first sensor type, wherein:
the compression is carried out using the encoder module specific to the sensor generation of the first sensor type and the encoder module.

5. The method according to claim 1, further comprising:
emulating a sensor of the second sensor type based on the generated synthetic sensor data.

6. The method according to claim 1, further comprising:
providing further sensor data, wherein the further sensor data is specific to the second sensor type and represents an identical scene as the sensor data, wherein the further sensor data results from a detection of at least one further sensor;
comparing the detected further sensor data to the generated synthetic sensor data; and
detecting a fault or an interference of the at least one further sensor based on a result of the comparison.

7. The method according to claim 6, further comprising:
balancing the fault or the impairment of at least one further sensor based on the synthetic sensor data by modifying the further detected sensor data based on the synthetic sensor data.

8. The method according to claim 1, further comprising generating or verifying at least one label for a training of a machine-learning model in a training data set, wherein:
the training data set is specific to sensor data of the second sensor type.

9. The method according to claim 1, wherein the sensor data and the synthetic sensor data are specific to a road traffic, the method further comprising:
generating or adjusting a road signature based on the generated synthetic sensor data.

10. A computer program comprising instructions for causing the computer to carry out the method according to claim 1 when the computer program is executed by a computer.

11. An apparatus for data processing, configured to carry out the method according to claim 1.

12. A computer-readable storage medium comprising instructions which, when executed by a computer, cause it to carry out the steps of the method according to claim 1.

13. The method according to claim 1, wherein:
the encoder module, the common decoder module, and the decoder module specific to the specific sensor generation of the second sensor type are each a neural network, and
the encoder module is a foundation machine-learning model.
